(19) United States
(12) Patent Application Publication
(10) Pub. No.: US 2022/0376534 A1
(43) Pub. Date: Nov. 24, 2022

(54) BATTERY CAPACITY VARIABLE CONTROL APPARATUS AND METHOD

(71) Applicants: Hyundai Motor Company, Seoul (KR); Kia Corporation, Seoul (KR)

(72) Inventor: Hyun Soo PARK, Seoul (KR)

(73) Assignees: Hyundai Motor Company, Seoul (KR); Kia Corporation, Seoul (KR)

(21) Appl. No.: 17/518,290

(22) Filed: Nov. 3, 2021

(30) Foreign Application Priority Data
May 21, 2021 (KR) 10-2021-0065154

(51) Int. Cl. H02J 7/00; B60L 58/13

(52) U.S. Cl. CPC H02J 7/0048; B60L 58/13

(57) ABSTRACT

A battery capacity variable control apparatus includes a sensor unit configured to measure an electrical characteristic value of a battery to output real SOC information, an input unit electrically connected to the sensor unit and configured to set a capacity limit rate of the battery based on the real SOC information output by the sensor unit, and a control unit electrically connected to the input unit and configured to selectively vary a use region where the battery is charged or discharged according to the capacity limit rate set by the input unit to output virtual setting SOC information, and to set a usage of the battery according to the virtual setting SOC information.

### CROSS-REFERENCE TO RELATED APPLICATION

The present application claims priority to Korean Patent Application No. 10-2021-0065154 filed on May 21, 2021, the entire contents of which is incorporated herein for all purposes by this reference.

### BACKGROUND OF THE INVENTION

### Field of the Invention

The present invention relates to a battery capacity variable control apparatus and method, and more specifically, to a battery capacity variable control apparatus and method, which may vary a capacity of a high-voltage battery mounted on an electric vehicle as necessary, improving durability performance of the battery.

### Description of Related Art

Generally, a state of charge (SOC) is controlled to be constant within a certain range in electric vehicles including hybrid electric vehicles.

Such a control is referred to as an SOC balancing control, and the SOC or a range of the SOC to be maintained in such an SOC balancing is referred to as a center SOC.

In other words, a general electric vehicle utilizes most of the whole SOC section of the high-voltage battery to secure a distance to empty, and unlike the electric vehicle, the hybrid electric vehicle (HEV) operates the battery based on a specific center SOC rather than using the whole section of the high-voltage battery.

Therefore, if a real SOC during traveling deviates from the center SOC, the HEV performs a control of changing the SOC without performing an efficient control such as an operation point control of an optimal operation line.

At the present time, efficiency of the system may be lowered, and fuel efficiency may be lowered, and a main reason why the real SOC may not be positioned at the center SOC may result from drivers' different driving characteristics (a rapid acceleration or deceleration traveling, an extreme traveling, or the like), charging and discharging characteristics, and/or different traveling conditions (which may be an uphill or downhill traveling or stagnant traveling).

Furthermore, it is advantageous in that the battery is used in a low SOC region if possible in terms of safety and durability. In other words, an optimal SOC use section may be different according to the system for the vehicle and the characteristics of the battery, and if this is efficiently controlled, it is possible to implement an optimal control in terms of durability and fuel efficiency of the battery.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a battery capacity variable control apparatus and method, which may enable a long-distance traveling using a limited residual capacity of a battery in an emergency traveling mode even while optimally maintaining durability performance of the battery by selectively limiting a real use region of the battery according to an operation pattern, charging and discharging patterns, or the like of the battery with respect to a capacity of the battery mounted on an electric vehicle, efficiently using the battery to extend a battery life.

A battery capacity variable control apparatus according to various exemplary embodiments of the present invention includes a sensor unit configured to measure an electrical characteristic value of a battery to output real SOC information, an input unit electrically connected to the sensor unit and configured to set a capacity limit rate of the battery based on the real SOC information output by the sensor unit, and a control unit electrically connected to the input unit and configured to selectively vary a use region where the battery is charged or discharged according to the capacity limit rate set by the input unit to output virtual setting SOC information, and to set a usage of the battery according to the virtual setting SOC information.

Here, the control unit is configured to selectively set upper limit SOC information and lower limit SOC information of the battery according to the capacity limit rate, and the virtual setting SOC information is set by excluding the upper limit SOC information and the lower limit SOC information from reference SOC information.

In response that a driving of a vehicle in a preset emergency traveling mode is requested by a driver's input, the control unit is configured to determine whether the vehicle is driven in the emergency traveling mode, and when the vehicle is driven in the emergency traveling mode, the lower limit SOC information is included in the virtual setting SOC information.

Furthermore, the input unit is configured to set the capacity limit rate by a driver's input based on the real SOC information, or to set the capacity limit rate by an input of a certified diagnosis device.

Furthermore, the input unit is configured to receive information from a database in which an operation pattern and charging and discharging patterns of the battery are stored, and analyzes the operation pattern and the charging and discharging patterns to set the capacity limit rate.

Meanwhile, a battery capacity variable control method according to various exemplary embodiments of the present invention includes outputting, by a sensor unit, real SOC information by measuring an electrical characteristic value of a battery, setting, by an input unit electrically connected to the sensor unit, a capacity limit rate of the battery, based on the real SOC information output by the sensor unit, and outputting, by a control unit electrically connected to the input unit, virtual setting SOC information by selectively varying a use region where the battery is charged or discharged, based on the capacity limit rate set by the input unit.

Here, when a driving request in a preset emergency traveling mode according to a driver's input is delivered, the outputting of the virtual setting SOC information includes determining, by the control unit, whether a vehicle is driven in the emergency traveling mode.

At the present time, when having determined that the vehicle is not in the emergency traveling mode, the control unit is configured to output a traveling distance, a traveling strategy, and charging control information based on the virtual setting SOC information

Furthermore, the outputting of the virtual setting SOC information further includes selectively setting, by the control unit, upper limit SOC information and lower limit SOC information of the battery according to the capacitive limit rate, and the virtual setting SOC information is set by excluding the upper limit SOC information and the lower limit SOC information from reference SOC information.

Furthermore, in the determining of the emergency traveling mode determines, when the control unit concludes that the vehicle is in the emergency traveling mode, the lower limit SOC information is included in the virtual setting SOC information.

The present invention may enable the long-distance traveling using the limited residual battery capacity in the emergency traveling mode even while optimally maintaining durability performance of the battery by selectively limiting the real use region of the battery according to the operation pattern of the battery, the charging or discharging pattern, or the like with respect to the capacity of the battery mounted on the electric vehicle, efficiently using the battery to extend the battery life.

Furthermore, the present invention may freely limit the real use region of the battery according to the driver's input, and at the instant time, set the real use region of the battery as the most efficient section in terms of durability and output, easily operating the battery such as operating the battery with a small capacity with respect to the high-voltage battery used for the electric vehicle.

It is understood that the term “automotive” or “vehicular” or other similar term as used herein is inclusive of motor automotives in general such as passenger vehicles including sports utility automotives (operation SUV), buses, trucks, various commercial automotives, watercraft including a variety of boats and ships, aircraft, and the like, and includes hybrid automotives, electric automotives, plug-in hybrid electric automotives, hydrogen-powered automotives and other alternative fuel automotives (e.g., fuels determined from resources other than petroleum). As referred to herein, a hybrid automotive is an automotive that has two or more sources of power, for example both gasoline-powered and electric-powered automotives.

The above and other features of the present invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram schematically illustrating a battery capacity variable control apparatus according to various exemplary embodiments of the present invention.

FIG. 2 is a diagram of various exemplary embodiments illustrating setting SOC information for the battery capacity variable control apparatus according to the exemplary embodiment of the present invention.

FIG. 3 is a diagram of various exemplary embodiments illustrating the setting SOC information for the battery capacity variable control apparatus according to the exemplary embodiment of the present invention.

FIG. 4 is a diagram illustrating the setting SOC information according to a request for an emergency traveling mode for the battery capacity variable control apparatus according to the exemplary embodiment of the present invention.

FIG. 5 is a diagram illustrating the setting SOC information compared to real SOC information for the battery capacity variable control apparatus according to the exemplary embodiment of the present invention.

FIG. 6 is a diagram sequentially illustrating a battery capacity variable control method according to various exemplary embodiments of the present invention.

FIG. 7 is a diagram illustrating an SOC conversion graph for the battery capacity variable control method according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, of the present invention an exemplary embodiment of the present invention will be described in detail with reference to the accompanying drawings.

Advantages and features of the present invention, and a method for achieving the same will become apparent with reference to the exemplary embodiments to be described later in detail

However, the present invention is not limited to the exemplary embodiments included below, but will be implemented in various different forms, and only these embodiments allow the present invention of the present invention to be complete, and are provided to fully inform those skilled in the art to which various exemplary embodiments of the present invention pertains of the scope of the present invention, and the present invention is only defined by the scope of the claims.

Furthermore, in describing the present invention, if it is determined that related known technologies may obscure the gist of the present invention, a detailed description thereof will be omitted.

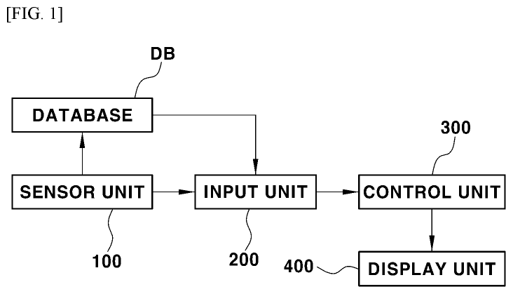

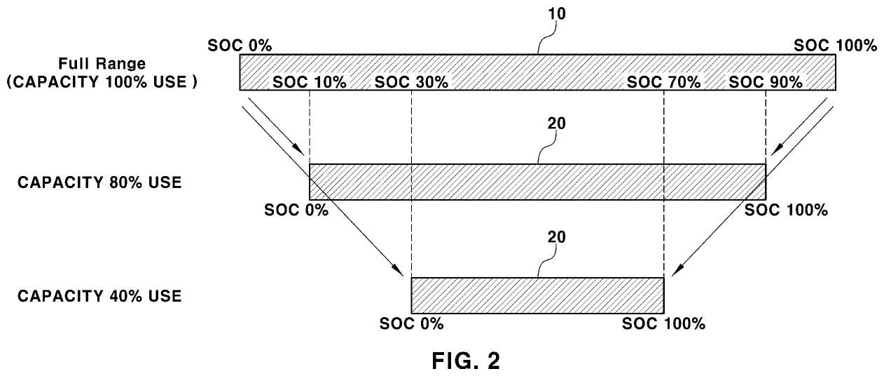

FIG. 1 is a diagram schematically illustrating a battery capacity variable control apparatus according to various exemplary embodiments of the present invention, and FIG. 2 is a diagram of various exemplary embodiments illustrating setting SOC information for the battery capacity variable control apparatus according to the exemplary embodiment of the present invention.

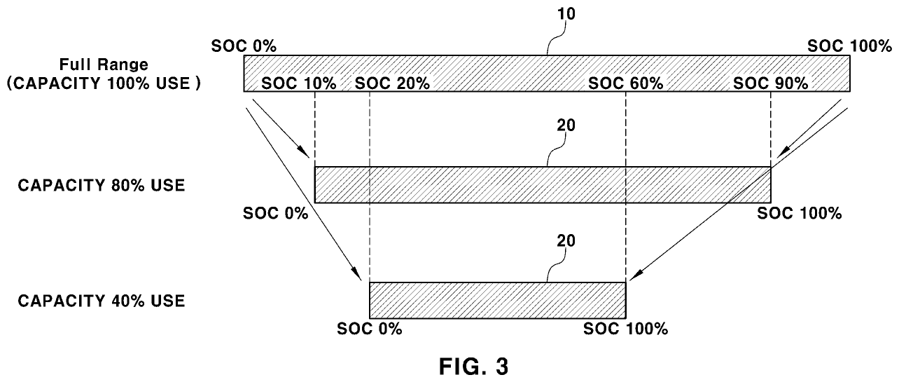

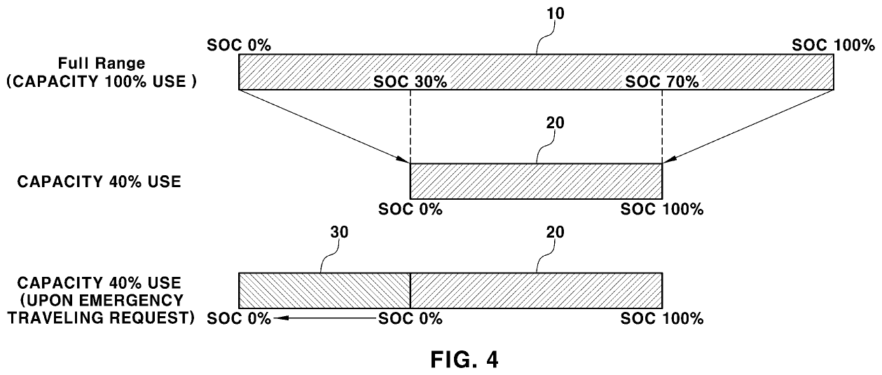

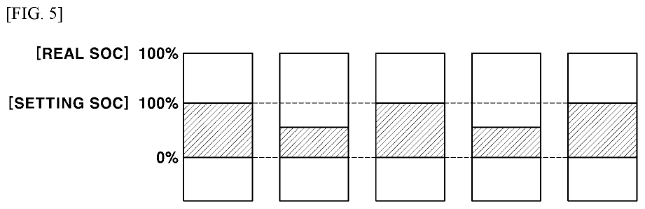

Furthermore, FIG. 3 is a diagram of various exemplary embodiments illustrating the setting SOC information for the battery capacity variable control apparatus according to the exemplary embodiment of the present invention, FIG. 4 is a diagram illustrating the setting SOC information according to a request for an emergency traveling mode for the battery capacity variable control apparatus according to the exemplary embodiment of the present invention, and FIG. 5 is a diagram illustrating the setting SOC information compared to real SOC information for the battery capacity variable control apparatus according to the exemplary embodiment of the present invention.

Generally, a secondary battery having electrical characteristics such as a high ease of application according to a product group and a high energy density is applied as a battery which is a power supply source for an electric vehicle (EV) or a hybrid electric vehicle (HEV) driven by an electrical driving source or an energy storage system (ESS) as well as for a portable device.

Such a battery normally includes one or more cells, and a type of cell is not specially limited, and the cell may be composed of a secondary battery such as a rechargeable lithium ion battery, lithium polymer battery, nickel cadmium battery, nickel hydrogen battery, or nickel zinc battery.

The battery has the characteristic in that performance is gradually degraded as charging and discharging are repeated, and such degradation may be confirmed by a phenomenon in which a capacity of the battery is gradually decreased as charging and discharging cycles of the battery are increased.

The cause of the degradation of the battery may be mainly found in the irreversibility of the electrochemical reaction, and in other words, when the charging and discharging cycles of the battery are increased, the characteristics of the material involved in the electrochemical reaction deteriorate by an aging effect such that the electrochemical reaction accompanying upon charging and discharging is not reversible.

Generally, the degradation of the battery results in a decrease in a usable electrical energy such that a use time of an apparatus or a device configured to receive an energy from the battery is decreased, and the output characteristic is lowered.

For example, in the electric vehicle, when the battery is degraded, a distance at which the electric vehicle may be operated on a single charge is decreased as much as the degradation of the battery even when the electric vehicle is operated under the same condition such that a technology configured for constantly maintaining performance regardless of the degree of degradation needs to be combined with the battery used for the electric vehicle.

In other words, when the charging and discharging cycles frequently occur as the vehicle repeatedly travels a short traveling distance, the battery is repeatedly used only in a high state of charge (SOC) region, and furthermore, when the battery is intermittently charged, the battery is used in a wide available range compared to a required capacity.

Therefore, due to the basic characteristics of the battery including the lithium ion battery or the lithium polymer battery used for the vehicle, when the battery is repeatedly used in the high state of charge (SOC) region or the wide available range, durability of the battery is inevitably lowered in general.

To the present end, as illustrated in FIG. 1, the battery capacity variable control apparatus according to the exemplary embodiment of the present invention includes a sensor unit 100, an input unit 200, and a control unit 300.

First, the sensor unit 100 measures an electrical characteristic value of the battery to output real state of charge (SOC) information.

Here, the electrical characteristic value means a voltage of the battery, a current flowing through a wire upon charging or discharging, a temperature of the battery, or the like, and the electrical characteristic value is measured to confirm a state of the battery such as a determination of a charging or discharging capacity or an SOC estimation.

To the present end, the sensor unit 100 measures the electrical characteristic value of the battery by a control signal of the control unit 300.

The measurement of the electrical characteristic value by the sensor unit 100 may be periodically performed at a preset interval, and may also be performed by a user's request or a request of an upper system configured to manage the control unit 300.

Although not illustrated, the sensor unit 100 may include a separate voltage meter, current meter, and/or temperature meter.

The voltage meter is configured to measure the entire voltage of the battery and/or a voltage of each cell included in the battery, the current meter is configured to measure a magnitude of a current flowing through a resistance element connected between the battery and a power supply means or a load upon charging or discharging the battery, and the temperature meter is configured to measure a temperature of the battery upon charging or discharging the battery.

It may be understood that the sensor unit 100 is not limited to the voltage meter, the current meter, and the temperature meter, and also includes all measurement devices configured for sensing the electrical characteristics of the battery.

Furthermore, the input unit 200 sets a capacity limit rate of the battery based on the real SOC information repeatedly output by the sensor unit 100.

The input unit 200 may also receive the corresponding information from a database (DB) in which an operation pattern and charging and discharging patterns determined by cumulating the real SOC information output by the sensor unit 100 are stored, and automatically set the capacity limit rate using the received operation pattern and charging and discharging patterns.

Furthermore, the input unit 200 may set the capacity limit rate by an input through a driver's input, that is, an input through a cluster for a vehicle, an audio video navigation (AVN) menu, or the like, based on the real SOC information measured by the sensor unit 100, or also set the capacity limit rate using a certified diagnosis device, for example, a diagnosis tool or a scanner.

As a result, as described above, the input unit 200 may set the capacity limit rate using a combination of the method for automatically setting the capacity limit rate using the operation pattern and the charging and discharging patterns and the method for directly setting the capacity limit rate using the driver's input or the diagnosis device.

Meanwhile, the control unit 300 selectively varies a use region where the battery is charged or discharged according to the capacity limit rate set by the input unit 200 to output virtual setting SOC information 20 on a display unit 400.

In other words, with respect to reference SOC information 10 using 0% to 100% as the use region, when the capacity limit rate is set by the input unit 200, the control unit 300 varies the use region based on the capacity limit rate to output the corresponding virtual setting SOC information 20 to be displayed on the display unit 400, such as the cluster for the vehicle or the AVN menu.

The control unit 300 may set the usage of the battery according to the setting SOC information 20, and the thus set setting SOC information 20 may have the capacity limit rate set as 20% or 60%, for example, and the use region excluding the capacity limit rate from the reference SOC information 10 may have a low frequency of the high SOC region for the battery, and be a region having the characteristic of a relatively low available range, that is, an optimal durability performance and charging and discharging performance.

As illustrated in FIG. 2, the control unit 300 according to the exemplary embodiment of the present invention sets upper limit SOC information and lower limit SOC information 30 as the capacity limit rate is set as 20%, and the setting SOC information 20 is set by excluding the upper limit SOC information and the lower limit SOC information 30 from the reference SOC information 10 using 0% to 100% as the use region.

In other words, as the capacity limit rate is set as 20% by the input unit 200, the control unit 300 sets each of the upper limit SOC information and the lower limit SOC information 30 as 10% to use 10% to 90% of the reference SOC information 10 as the virtual setting SOC information 20, and processes and outputs the virtual setting SOC information 20 to correspond to 100% of the use region.

Therefore, when the driver confirms the use region through the cluster for the vehicle or the AVN menu, the use region corresponding to 10% to 90% of the reference SOC information may be confirmed as the setting SOC information 20, and as a result, the driver may control the vehicle using only the use region corresponding to the setting SOC information 20 other than the upper limit SOC information and the lower limit SOC information 30, preventing a problem in that the battery is repeatedly used in the high SOC region or used in a wide available range compared to the required capacity, lowering durability of the battery.

Furthermore, as a result of analyzing the operation pattern and the charging and discharging patterns, if the capacity limit rate is set as 60% by the input unit 200, the control unit 300 may also set each of the upper limit SOC information and the lower limit SOC information 30 as 30% to process and output 30% to 70% of the reference SOC information 10 to correspond to 100% of the virtual setting SOC information 20.

Furthermore, as illustrated in FIG. 3, the control unit 300 according to the exemplary embodiment of the present invention sets the upper limit SOC information and the lower limit SOC information 30 as the capacity limit rate is set as 20%, and the setting SOC information 20 is set by excluding the upper limit SOC information and the lower limit SOC information 30 from the reference SOC information 10 using 0% to 100% as the use region.

In other words, as the capacity limit rate is set as 20% by the input unit 200, the control unit 300 sets each of the upper limit SOC information and the lower limit SOC information as 10% to process and output 10% to 90% of the reference SOC information to correspond to 100% of the virtual setting SOC information.

Therefore, when the driver confirms the use region through the cluster for the vehicle or the AVN menu, the use region corresponding to 10% to 90% of the reference SOC information may be confirmed as the setting SOC information, and as a result, the driver may control the vehicle using the use region corresponding to the setting SOC information 20 excluding the upper limit SOC information and the lower limit SOC information 30 from the reference SOC information 10, preventing a problem in that the battery is repeatedly used in the high SOC region, lowering durability of the battery.

According to the exemplary embodiment of the present invention, if the capacity limit rate is set as 60% by the input unit 200, the control unit 300 sets each of the upper limit SOC information and the lower limit SOC information 30 as 30%, and unlike the aforementioned exemplary embodiment of the present invention, the control unit 300 may also process and output 20% to 60% of the reference SOC information 10 as the virtual setting SOC information 20.

This is to process and output the setting SOC information as the virtual setting SOC information 20 using 30% to 70% or 20% to 60% of the reference SOC information 10, which is most advantageous for durability and output according to the type or the characteristics of the battery, as 100% even if the capacity limit rate is set as 60% by the input unit 200 because the available SOC information may be different according to the type or the characteristics of the battery.

In other words, since the region of the battery, which is advantageous for durability and output, that is, configured for implementing the optimal performance, may be generally a low SOC region, unlike the aforementioned exemplary embodiment of the present invention, the setting SOC information is processed and output as the virtual setting SOC information 20 using 20% to 60% of the reference SOC information 10 as 100% according to the type or the characteristics of the battery.

Although it has been described that the setting SOC information 20 is processed as 30% to 70% or 20% to 60% of the reference SOC information 10 as the capacity limit rate is set as 60% by the input unit 200, this is not determined, and the setting SOC information 20 may also be processed in another range which is most advantageous for durability and output according to the type or the characteristics of the battery within the capacity limit rate, outputting the virtual setting SOC information.

Meanwhile, as illustrated in FIG. 4, the control unit 300 converts the lower limit SOC information 30 included in the real SOC information to be included in the virtual setting SOC information 20 when the vehicle is driven in a preset emergency traveling mode such that the virtual setting SOC information 20 using it as 100% is output.

As an example, the emergency traveling mode may be set as a long-distance traveling mode, and if the battery is repeatedly used only in the high SOC region and the battery is used in the wide available range compared to the required capacity but a destination of a predetermined distance or more is set using navigation information or the like, the emergency traveling mode may be set.

Therefore, as in the aforementioned various exemplary embodiments of the present invention, if the virtual SOC information is output by setting the capacity limit rate as 60% and setting each of the upper limit SOC information and the lower limit SOC information 30 as 30% by the input unit 200, when the vehicle is driven in the emergency traveling mode, as illustrated in FIG. 4, 30% of the lower limit SOC information is included in the virtual setting SOC information 20 (because the region configured for implementing the optimal performance is the low SOC region), and as a result, the setting SOC information 20 corresponding to 0% to 70% of the reference SOC information 10 may be output.

Therefore, the exemplary embodiment of the present invention may reduce a 100% range of the reference SOC information for the setting SOC information 20 compared to the real SOC information used according to the use frequency and available range of the battery, and as illustrated in FIG. 5, the setting SOC information 20 may be processed and output within the corresponding range of the reference SOC information, optimally maintaining durability performance of the battery.

Furthermore, the exemplary embodiment of the present invention may use a residual capacity when the vehicle is driven in the emergency traveling mode, providing the degree of freedom facilitating the driver to conduct the battery durability-oriented operation.

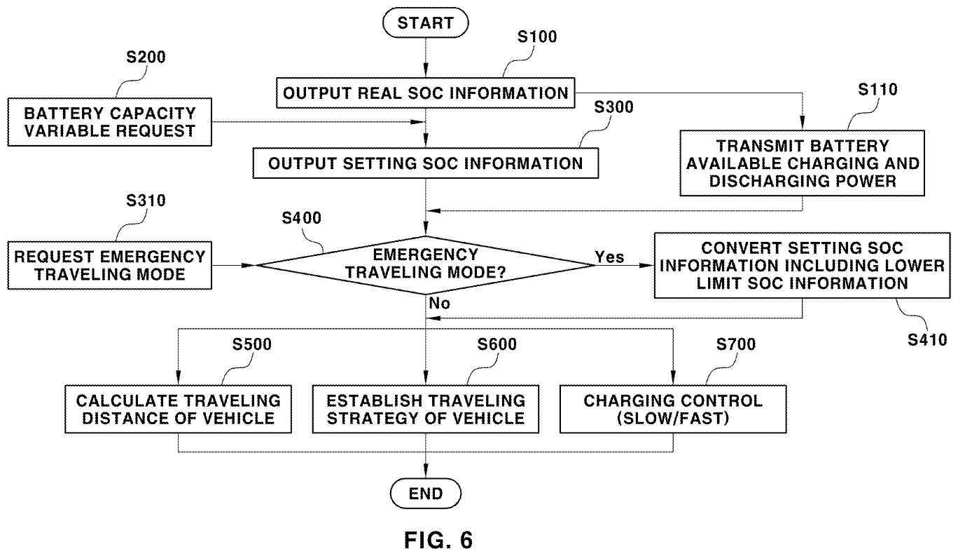

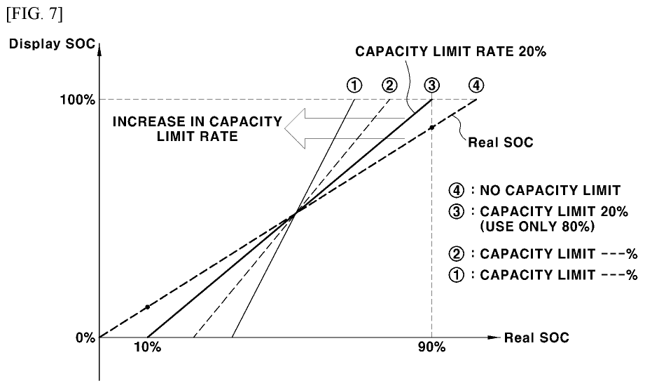

Hereinafter, FIG. 6 is a diagram sequentially illustrating a battery capacity variable control method according to various exemplary embodiments of the present invention, and FIG. 7 is a diagram illustrating an SOC conversion graph for the battery capacity variable control method according to various exemplary embodiments of the present invention.

As illustrated in FIG. 6, the capacity variable control method according to the exemplary embodiment of the present invention will be sequentially referred to as follows.

The real SOC information is output by measuring the electrical characteristic value of the battery by the sensor unit 100 (S100).

The capacity limit rate of the battery is set by the input unit 200, based on the real SOC information output by the sensor unit 100 (S200).

Here, the input unit 200 may also receive the corresponding information from the database (DB) in which the operation pattern and the charging and discharging patterns determined by cumulating the real SOC information output by the sensor unit 100 are stored, and analyze the thus received operation pattern and charging and discharging patterns to automatically set the capacity limit rate.

Furthermore, the input unit 200 may set the capacity limit rate by the input through the driver's input, that is, the input by the cluster for the vehicle or the audio video navigation (AVN) menu, based on the real SOC information measured by the sensor unit 100, or also set the capacity limit rate using the certified diagnosis device, for example, the diagnosis tool or the scanner.

As a result, as described above, the input unit 200 may set the capacity limit rate using a combination of the method for automatically setting the capacity limit rate using the operation pattern and the charging and discharging patterns and the method for directly setting the capacity limit rate using the driver's input or the diagnosis device.

As described above, the virtual setting SOC information 20 corresponding to 30% to 70% of the reference SOC information 10 is output by selectively varying the use region where the battery is charged or discharged by the control unit 300, based on the capacity limit rate, for example, 60% of the capacity limit rate set by the input unit 200 (S300).

As illustrated in FIG. 7, the virtual setting SOC information 20 may be output in a form of a linear function, and for example, when 10% to 90% of the reference SOC information 10 is processed to correspond to 100% of the virtual setting SOC information by setting the capacity limit rate as 20%, the setting SOC information may be output by a conversion formula of 1.25*x−12.5 (x refers to the real SOC value).

For reference, the SOC conversion formula may be differently set according to the capacity limit rate, and as a result, as the capacity limit rate increases, a slope may also be formed in an increasing form.

If the driving request in the preset emergency traveling mode is delivered by the driver's input (S310), the control unit 300 receives the upper limit SOC information and the lower limit SOC information corresponding to 0% to 30% and 70% to 100% of the reference SOC information 10, which is processed for the available charging and discharging power of the battery, that is, the output of the virtual setting SOC information 20 (S110), and as a result, whether the vehicle is driven in the emergency traveling mode is determined (S400).

As an example, the emergency traveling mode may be set as the long-distance traveling mode, and if the battery is repeatedly used only in the high SOC region and the battery is used in the wide available range compared to the required capacity but the destination of the predetermined distance or more is set using the navigation information or the like, the emergency traveling mode may be set.

If it is determined that the emergency traveling mode set as described above should be performed by determining whether the vehicle is driven in the emergency traveling mode (S400), based on the upper limit SOC information and the lower limit SOC information 30 including in the input real SOC information (S110), the setting SOC information 20 is converted into the virtual setting SOC information 20, that is, the virtual setting SOC information 20 including the lower limit SOC information 30 (S410).

As described above, as a result of determining whether the vehicle is driven in the emergency traveling mode (S400), when the setting SOC information 20 including the lower limit SOC information 30 is output (S410) or the virtual setting SOC information 20 corresponding to 30% to 70% of the reference SOC information 10 is selectively output, a traveling distance of the vehicle is selectively determined and output using the output SOC information (S500), a traveling strategy of the vehicle such as a charging warning is output (S600), or charging control information such as a slow or fast charging is output (S700).

Therefore, the exemplary embodiment of the present invention may enable the selective traveling using the capacity of the battery according to the limited setting SOC information 20 or using the capacity of the battery according to the setting SOC information 20 including the lower limit SOC information 30 even while optimally maintaining durability performance of the battery by selectively limiting the real use region of the battery according to the charging and discharging patterns or the like, efficiently using the battery to extend the battery life.

The present invention may enable the long-distance traveling using the limited residual capacity of the battery in the emergency traveling mode even while optimally maintaining durability performance of the battery by selectively limiting the real use region of the battery according to the operation pattern and the charging and discharging patterns of the battery with respect to the capacity of the battery mounted on the electric vehicle, efficiently using the battery to extend the battery life.

Furthermore, the present invention may freely limit the real use region of the battery according to the driver's input, and at the instant time, set the real use region of the battery as the most efficient section in terms of durability and output, easily operating the battery such as operating the battery with a small capacity with respect to the high-voltage battery used for the electric vehicle.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

In various exemplary embodiments of the present invention, each operation described above may be performed by a control device, and the control device may be configured by a plurality of control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A battery capacity variable control apparatus including:
a sensor unit configured to measure an electrical characteristic value of a battery to output real SOC information of the battery;
an input unit electrically connected to the sensor unit and configured to set a capacity limit rate of the battery based on the real SOC information output by the sensor unit; and
a control unit electrically connected to the input unit and configured to selectively vary a use region where the battery is charged or discharged according to the capacity limit rate set by the input unit to output virtual setting SOC information, and to set a usage of the battery according to the virtual setting SOC information.

2. The battery capacity variable control apparatus of claim 1,
wherein the control unit is configured to selectively set upper limit SOC information and lower limit SOC information of the battery according to the capacity limit rate, and
wherein the virtual setting SOC information is set by excluding the upper limit SOC information and the lower limit SOC information from reference SOC information.

3. The battery capacity variable control apparatus of claim 2,
wherein in response that a driving of a vehicle in a preset emergency traveling mode is requested by a driver's input, the control unit is configured to determine whether the vehicle is driven in the emergency traveling mode, and when the vehicle is driven in the emergency traveling mode, the lower limit SOC information is included in the virtual setting SOC information.

4. The battery capacity variable control apparatus of claim 3,
wherein when having determined that the vehicle is not in the emergency traveling mode, the control unit is configured to output a traveling distance of the vehicle, a traveling strategy of the vehicle, and charging control information of the battery based on the virtual setting SOC information.

5. The battery capacity variable control apparatus of claim 1,
wherein the input unit is configured to set the capacity limit rate by a driver's input based on the real SOC information, or to set the capacity limit rate by an input of a certified diagnosis device.

6. The battery capacity variable control apparatus of claim 1,
wherein the input unit is configured to receive information from a database in which an operation pattern and charging and discharging patterns of the battery are stored, and is configured to analyze the operation pattern and the charging and discharging patterns to set the capacity limit rate.

7. A battery capacity variable control method including:
outputting, by a sensor unit, real SOC information of a battery by measuring an electrical characteristic value of the battery;
setting, by an input unit electrically connected to the sensor unit, a capacity limit rate of the battery, based on the real SOC information output by the sensor unit; and
outputting, by a control unit electrically connected to the input unit, virtual setting SOC information by selectively varying a use region where the battery is charged or discharged, based on the capacity limit rate set by the input unit.

8. The battery capacity variable control method of claim 7,
wherein when a driving request in a preset emergency traveling mode according to a driver's input is delivered, the outputting of the virtual setting SOC information includes determining, by the control unit, whether a vehicle is driven in the emergency traveling mode.

9. The battery capacity variable control method of claim 8,
wherein when having determined that the vehicle is not in the emergency traveling mode, the control unit is configured to output a traveling distance of the vehicle, a traveling strategy of the vehicle, and charging control information of the battery based on the virtual setting SOC information.

10. The battery capacity variable control method of claim 8,
wherein the outputting of the virtual setting SOC information further includes selectively setting, by the control unit, upper limit SOC information and lower limit SOC information of the battery according to the capacitive limit rate, and
wherein the virtual setting SOC information is set by excluding the upper limit SOC information and the lower limit SOC information from reference SOC information.

11. The battery capacity variable control method of claim 10,
wherein in the determining of the emergency traveling mode, when the control unit concludes that the vehicle is in the emergency traveling mode, the lower limit SOC information is included in the virtual setting SOC information.

12. The battery capacity variable control method of claim 10,
wherein the input unit is configured to set the capacity limit rate by a driver's input based on the real SOC information, or to set the capacity limit rate by an input of a certified diagnosis device.

13. The battery capacity variable control method of claim 10,
wherein the input unit is configured to receive information from a database in which an operation pattern and charging and discharging patterns of the battery are stored, and is configured to analyze the operation pattern and the charging and discharging patterns to set the capacity limit rate.

14. A non-transitory computer readable storage medium on which a program for performing the battery capacity variable control method of claim 7 is recorded.
